(19) United States
(12) Patent Application Publication
(10) Pub. No.: US 2008/0262825 A1
(43) Pub. Date: Oct. 23, 2008

(54) ARRANGEMENT FOR TRANSMITTING INFORMATION

(75) Inventors: Josef Haid, Graz (AT); Thomas Leutgeb, Lieboch (AT); Dietmar Scheiblhofer, Kaindorf (AT); Bernd Zimek, Graz (AT)

Correspondence Address: DICKSTEIN SHAPIRO LLP, 1177 AVENUE OF THE AMERICAS 6TH AVENUE, NEW YORK, NY, 10036-2714, US

(73) Assignee: INFINEON TECHNOLOGIES AG, Neubiberg (DE)

(21) Appl. No.: 11/743,532

(22) Filed: May 2, 2007

(30) Foreign Application Priority Data
Apr. 19, 2007 (DE) 10 2007 018 615.2

(51) Int. Cl. G06F 9/455

(52) U.S. Cl. 703/23

(57) ABSTRACT

Arrangement for bidirectionally transmitting information between a unit configured to emulate a data processing system and a data processing unit, wherein the data processing unit has a data input device and a data output device, the emulating unit is configured to generate emulator information, and the emulator information relates to a power budget for the emulated data processing system.

### CROSS REFERENCE TO RELATED APPLICATION

This application claims priority to German Patent Application Serial No. 10 2007 018 615.2 which was filed on Apr. 19, 2007, and is incorporated herein by reference in its entirety.

### BACKGROUND

The invention relates to an arrangement for transmitting information between a unit for emulating a data processing system and a data processing unit.

To analyze a data processing system in order to check full operability, nowadays mainly emulators are used. In this context, emulation in information processing systems refers to the functional reproduction of a system. An emulator is therefore a unit which imitates another data processing system. To achieve a meaningful analysis result, the reproducing system receives the same data, executes the same programs and applications and thereby achieves the same results as a corresponding original system.

Emulators are used for various purposes. First, they are a protection of investment because software which has been developed for earlier systems can continue to be used through emulation on more modern systems. A second aspect is software development support, because emulators allow software which is intended for another system to be developed and tested on a known or familiar system. A third great possibility for use is the use of emulators for training and test purposes.

With regard to a specified purpose, it makes sense in modern development processes and sales strategies to produce an emulator in addition to the actual product. For the field of chip cards, an emulator might be provided to a possible future purchaser who then can install and test the software required for his applications. The more information a system emulator provides, the more helpful it is for a further development and application process.

By way of example, an emulator is able to transfer data information from a current program cycle for an application, for example data packets, register levels, program counters, stack pointers etc. A debug interface, that is to say an interface for detecting, tracking and eliminating errors within an application, is used to make this information available usually to a data processing unit, for example a PC. An appropriate software tool installed on the PC, for example, can condition the transmitted data information and makes it available to the developer or purchaser.

Specifically for the field of chip cards, two types of emulators are used. The chip card emulators called bound-out chips correspond, in principle, to the finished chip cards in terms of function and electronics. The only difference from the chip cards is the much higher number of connections which are routed to the outside. These connections can be connected to a debug interface, from which the relevant information is then tapped of.

For some time, field programmable gate arrays (FPGAs) have been configured as bound-out chips. An FPGA is a programmable semiconductor component and contains configurable logic components which can produce a corresponding system. In terms of hardware, a developer therefore implements a chip card on an FPGA and a possible chip card purchaser installs the application which is of interest to him and can modify it as often as desired. To support the FPGA, specific emulator boards are often positioned between the FPGA and the data processing unit. Their task is to condition the information provided by the FPGA and to transmit this information to the data processing unit in standardized fashion, for example by USB.

A second type of emulator is what are known as microcontroller emulators. These do not require any additional connections to be routed to the outside.

For the purpose of use and development of chip cards, it is very important not only to receive the data information but also to receive power information, relating to the power budget, for a specific program cycle which is active at a particular time. Since especially contactless chip cards do not have a separate power supply available on an RFID tag, for example, but rather the power for operating the chip card is obtained from the electromagnetic field received, it is appropriate to develop very power-saving applications.

To establish a precise relationship between the power consumption and a program cycle, measuring appliances or software development tools have been used to date which, depending on the system to be imitated, always need to be reconfigured and/or procured afresh. Power information relating to a power budget continually refers to information which can be used to calculate power consumption at a particular time or in total for an overall process. In the simplest case, this information may be a single-bit signal. In addition, however, a more complex form of the information is also conceivable, where a plurality of bits are transmitted in the form of a protocol, for example, and represent this information. By way of example, power consumption refers to the current drawn and/or the power drawn by the system at a particular time and/or in a particular program cycle.

### BRIEF DESCRIPTION OF THE DRAWINGS

The invention is explained below using exemplary embodiments with reference to the drawings, where parts which are the same or have the same action in the figures are respectively identified by the same reference symbols. The elements shown are not to be considered as true to scale, but rather individual elements can be shown in exaggeratedly large or exaggeratedly simplified form in order to aid understanding.

FIG. 1 shows an exemplary embodiment of an arrangement for transmitting information,

FIG. 2 shows a schematic illustration of a development of the exemplary embodiment,

FIG. 3 shows a schematic illustration of an alternative development of the exemplary embodiment, and

FIG. 4 shows a schematic illustration of an alternative development of the exemplary embodiment.

### DESCRIPTION OF THE INVENTION

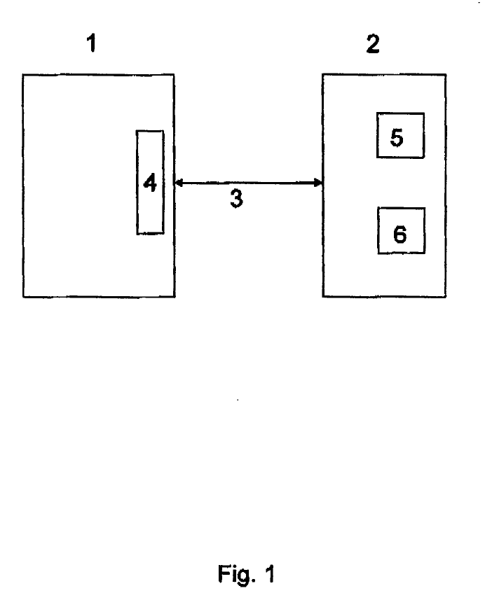

FIG. 1 shows an exemplary embodiment of an arrangement for transmitting information. A unit 1 for emulating a data processing system is connected to a data processing unit 2 via an interface 4 for a data transmission 3. The data processing unit 2 additionally contains a data input device 5 and a data output device 6.

The data transmission 3, which is designed to transmit information in both directions, transmits a plurality of types of information. To install different applications on the unit 1 emulating a data processing system, data information is sent from the data processing unit 2 to the unit 1 emulating a data processing system. So as now to observe the emulating system or to operate an error search or error elimination, for example, the unit 1 transmits functional data to the data processing unit 2. This emulator information is, for instance register levels, interrupt values, program counter values, stack pointer values and much more. In addition, this arrangement is also used to transmit emulator information relating to the power budget for the emulated system.

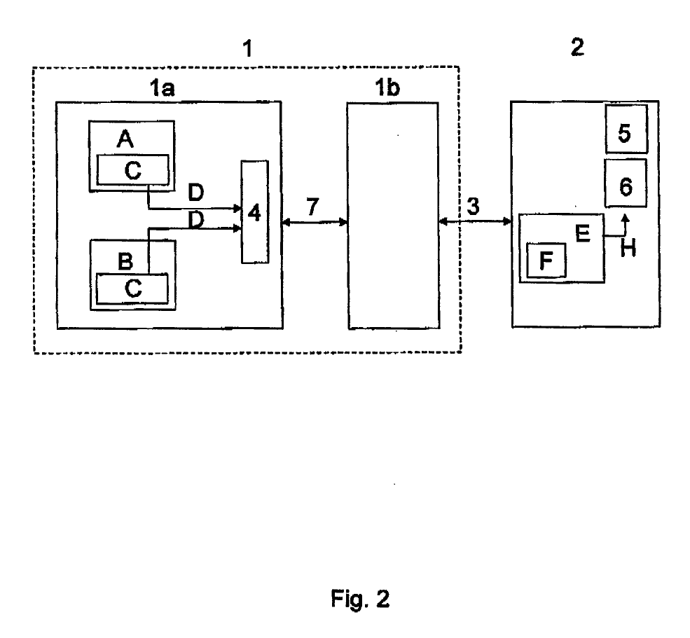

FIG. 2 shows a development of the exemplary embodiment for transmitting information. In this case, the unit 1 for emulating a data processing system contains at least one user-programmable logic chip 1a and a connecting unit 1b. The elements 1a and 1b are connected via an interface 4. The unit 1 for emulating a data processing system is again connected to the data processing unit 2 for data transmission 3 at both ends. The user-programmable logic chip 1a contains the data processing system to be emulated and the interface 4. In this case, the system to be emulated is divided into a plurality of, at least two, modules A and B. Each of the modules A and B contains a status reporting unit C. The data processing unit 2 contains at least one data input element 5 and a data output element 6. In addition, the data processing unit 2 has a power calculation unit E. This calculation unit E contains power information F stored in a data store.

Advantageously, the systems to be imitated are implemented on an FPGA in modules. Modules may be memories (ROM, RAM), a CPU, an analogue-digital converter (ADC) or an arithmetic-logical unit (ALU), for example. Each of these modules now has elements which provide emulator information relating to a power budget.

In this case, the user-programmable logic chip la contains the emulated system of modular design, with each of the modules A and B shown having a status reporting unit C. This status reporting unit C in each module A, B provides status reports D. These status reports D report the extent to which the relevant module A, B is active.

These status reports D may firstly be a one-bit signal, that is to say carry emulator information regarding whether the module A, B is active or not active. If the module A is a data store, for example, and this data store is accessed in a program cycle, then its status reporting unit C sends a logic 1 as status report D. If the data store is not being used, it sends a logic 0 as status report D.

Otherwise, a status report D may also contain substantially more complex information. If module B is a CPU, for example, then a status report D possibly contains the information Operation in “Idle Mode”, Interrupts Active, ALU Inactive.

These status reports D are made available to the interface 4 either directly or via a collecting unit (not shown). This interface 4 is an error search and elimination interface, that is to say a debug interface. The interface 4 is used to transmit the status reports D to the connecting unit 1b by means of a connection 7. The interface 4 is preferably part of the FPGA. This means that the interface 4 is configurable, that is to say that the use of the individual signal paths in the interface 4 can be selected. The connecting unit 1b links the interface 4 to the data processing unit 2 by means of a standardized connection 3. By way of example, universal serial transmission, also called USB, can be mentioned here. The connecting unit 1b is an emulator board in this case, for example. This connecting unit 1b is not absolutely essential for the essence of the invention, but is very advantageous on account of the possible great extent of the status reports D.

The data processing unit 2 is now sent not only the data information but also the status reports D via the standardized connection 3. The status reports D are picked up in a power calculation unit E in the data processing unit 2. The power information F stored in a data store and the status reports D can be used by the power calculation unit E to ascertain actual power information H. In this context, it is merely important for the stored power information F to be available to the data processing unit, for example it can also be supplied externally via the data input device (5).

If module A relates to the data store, one possible data store status report D might be a logic 1. If stored power information F for the active data store were to be 30 μA by way of example, actual power information H for this status report D would be 30 μA. For the example in which module B is a CPU, actual power information calculation is more complex but also more meaningful.

Appropriately rapid and data-intensive communication, for example USB, allows these calculations to be performed and presented during a particular program cycle.

The actual power information H is now delivered to the data output device 6 of the data processing unit 2. The more detailed the design of the status reporting unit C, and also the status reports D, the more accurately can the calculation unit E be used to make statements about the present actual power consumption through the actual power information H of the emulated system with the currently operated application in the present program cycle. Different applications and the resultant different power consumption of the emulated system means that this arrangement can be used to make detailed statements about the power requirement of individual cycles of an application at a particular time.

The power information F which is supplied to the calculation unit E and is stored in a data store is obtained in different ways. First, such power information F can be ascertained empirically in an experimental setup. These structures can usually be implemented only with a very high level of complexity; corresponding measurement structures and series of experiments are not discussed in more detail.

Secondly, it is possible to use simulation results from an application which simulates the emulated system. Since these simulation results are very reliable in today's prior art, these power requirement statements match the actual power values required by the emulated system very precisely.

A third variant for obtaining this power information F is to estimate the active chip area which requires a module A or B. This statement is converted into appropriate required power values.

Since this development of the exemplary embodiment makes a large number of pieces of information available to the data processing per clock or system cycle, the connection 3 needs to have a large bandwidth. Advantageously, the transmission is limited to what are known as delta values, which means that the actual status reports C themselves are not transmitted but rather possibly only the alterations to the status reports C.

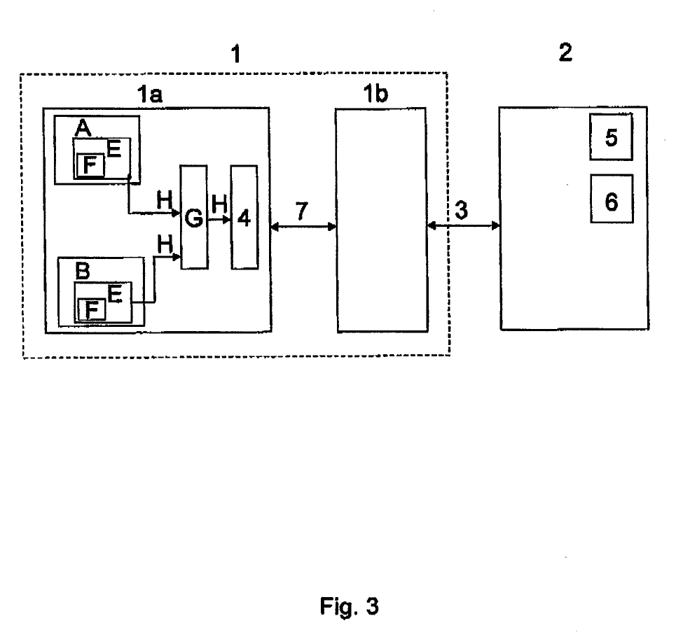

FIG. 3 shows an alternative development of the exemplary embodiment. FIG. 3 is highly similar to FIG. 2. In contrast to FIG. 2, the user-programmable logic chip 1a is configured differently. The likewise provided modules A and B in the emulated data processing system contain a power calculation unit E and a data store which contains stored power information F. In addition, the user programmable logic 1a has a power information collection unit G.

The power calculation unit E which is in modules A and B uses the stored power information F to calculate the actual power information H for the respective module. Module A, again presented as a data store, delivers the actual power information H, for example 30 μA, depending on its state. The power information collection unit G is used to forward this actual power information H to the interface 4.

The connecting unit 1b again sets up a standardized connection 3, for example USB, to the data processing unit 2. Since the actual power information H is already available in the individual modules A, B, it is not calculated in the data processing unit 2 and is available directly in the data processing unit 2 for forwarding to the data output unit 6.

In this case, such power information can also be transmitted as “delta values”, which merely provide the difference from preceding power values. This allows optimum use to be made of the respective bandwidth of the debug interface.

Unlike the previous development, a smaller number of pieces of information is transmitted. A drawback in comparison with exemplary embodiment 1 is the implementation of additional units and the provision of system performance and also data storage space for calculating power requirement.

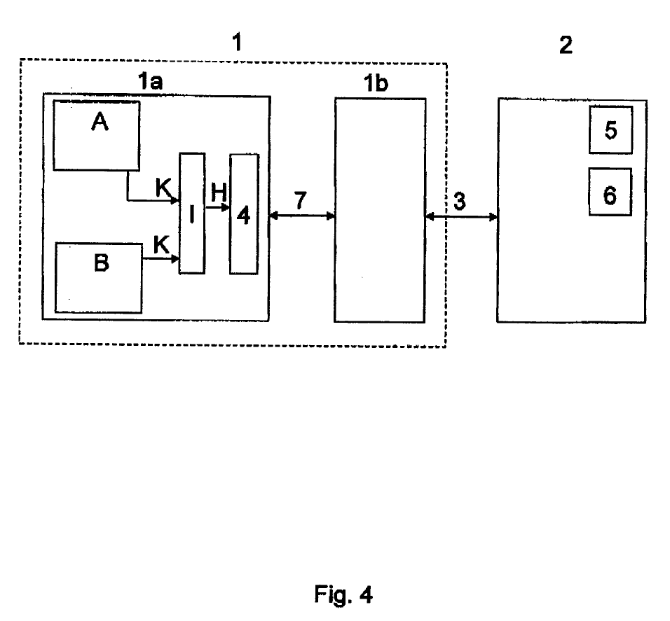

FIG. 4 shows a next alternative development of the exemplary embodiment. FIG. 4 is also very similar to FIGS. 2 and 3, which means that in this case too only the differences from the preceding figures are discussed. A fundamental difference is in turn the design of the user programmable logic chip 1a. In addition to the data processing system which is to be emulated, the user programmable logic chip 1a contains a measuring unit I.

This third option for obtaining the power information relating to the power budget for an emulated data processing system is the implementation of a measuring unit 1, for example in the form of a current-measuring instrument or power-measuring device etc. in the FPGA. The emulated system is of modular design in this case too. The measuring unit I ascertains actual power values K for the modules A, B, converts them into actual power information H and makes this information available to the interface 4.

In similar fashion to FIG. 3, FIG. 4 has the actual power information H made available on the user-programmable logic chip itself. The standardized connection 3 is likewise used for data transmission to the data processing unit 2. In the data processing unit 2, the actual power information H is made available directly to the data output device 6.

Although it is expedient to classify a data processing system to be emulated in the FPGA into modules, it is not directly relevant to the invention. It goes without saying that the data processing system can also provide the necessary power information in line with FIGS. 2, 3 and 4 on the whole.

What is claimed is:

1. An arrangement for bidirectionally transmitting information between an emulating unit configured to emulate a data processing system and a data processing unit, wherein:
the data processing unit comprises a data input device and a data output device,
the emulating unit is configured to generate emulator information, which relates to at least one power budget for the emulated data processing system, and
the emulator information is transmitted to the data processing unit via an interface.

2. The arrangement according to claim 1, wherein the emulator information relating to the power budget for the emulated data processing system is power information and/or information for calculating power information.

3. The arrangement according to claim 2, wherein the emulating unit is a user-programmable logic circuit.

4. The arrangement according to claim 3, wherein the user-programmable logic circuit comprises the data processing system to be emulated and an interface, and can be operated using different applications transmitted by the data processing unit.

5. The arrangement according to claim 4, wherein the data processing system to be emulated has at least two modules each comprising a status reporting unit.

6. The arrangement according to claim 5, wherein the status reporting units generate status reports and transmit the reports to the interface.

7. The arrangement according to claim 6, wherein the data processing unit comprises a power calculation unit to produce actual power information, the status reports are transmitted to the data processing unit via the interface, and the power calculation unit calculates the actual power information using power information, which is available to the data processing unit, is stored in the data processing unit, and relates to the power budget for the emulated data processing system.

8. The arrangement according to claim 4, wherein the emulated data processing system comprises at least two modules each comprising a power calculation unit and a data store with stored power information relating to the power budget for the emulated data processing system.

9. The arrangement according to claim 8, wherein the power calculation units use the stored information relating to the power budget of the emulated data processing system to generate actual power information, which is transmitted first to a power information collection unit and then via the interface to the data processing unit.

10. The arrangement according to claim 4, wherein the user-programmable logic circuit comprises a measuring unit and the system to be emulated has at least two modules, wherein actual power values for a module can be converted into actual power information in the measuring unit and transmitted via the interface to the data processing unit.

11. The arrangement according to claim 1, further comprising a connecting unit configured to transmit data, wherein the connecting unit provides a standardized connection between the user-programmable logic chip and the data processing unit.

12. The arrangement according to claim 11, wherein the interface is configurable.

13. The arrangement according to claim 11, wherein the stored information relating to the power budget for the system to be emulated is generated by means of measurement, simulation and/or chip area estimation.

14. A method for providing emulator information relating to a power budget using the arrangement according to claim 1, wherein the emulator information is generated by the emulating unit and is supplied via the interface to the data processing unit.

15. The method according to claim 14, wherein the data processing system emulation is of modular design and is configured using a data transmission.

16. The method according to claim 15, further comprising:
the modules generating status reports;
transmitting the status reports to the data processing unit for further data processing; and
converting, by the data processing unit, the status reports into actual power information using power calculation methods and power information, which is available to the data processing unit, is stored in the data processing unit, and relates to the power budget for the emulated system.

17. The method according to claim 15, further comprising:
the modules calculating actual power information using power calculation methods and power information, which is stored in a data store and relates to the power budget for the emulated system;
grouping the actual power information from the modules; and
supplying the actual power information directly to the data processing unit.

18. The method according to claim 15, further comprising:
ascertaining power required by a module using a measuring method and actual power values; and
converting the power into actual power information which is supplied directly to the data processing unit.

19. The method according to claim 14, further comprising a connecting unit generating a standardized data transmission.

20. An apparatus for ascertaining information relating to a power budget, wherein the information relating to the power budget is directly available, via an interface, on an emulating unit emulating a data processing system.

21. The apparatus according to claim 20, wherein the information relating to the power budget is power information and/or information used to calculate power information.

22. The apparatus according to claim 21, wherein the emulating unit is at least one user-programmable logic circuit, and data can be transmitted via a connecting unit, which sets up a standardized connection between the user-programmable logic chip and the data processing unit.

23. The apparatus according to claim 22, wherein the user-programmable logic chip has at least two modules, each configured to generate status reports in a respective status reporting unit, transmit these status reports to the interface and then to the data processing unit, and wherein the data processing unit is configured to calculate the status reports to produce actual power information.

24. The apparatus according to claim 22, wherein the user-programmable logic chip has at least two modules which respectively comprise a power calculation unit and stored information relating to the power budget for the emulating system, wherein the power calculation units generate actual power information which is transmitted via a power information collection unit and the interface to the data processing unit.

25. The apparatus according to claim 22, wherein the user-programmable logic chip comprises a measuring unit and the system to be emulated, which comprises at least two modules, wherein the measuring unit is configured to convert actual power values from the modules into actual power information and then transmit the actual power information via the interface to the data processing unit.

26. The apparatus according to claim 22, wherein the interface is configurable and the stored information relating to the power budget for the emulating system is obtained by means of measurement, simulation and/or chip area estimation.

27. An arrangement comprising:
a data processing unit comprising a data input device and a data output device; and
a data processing system emulating unit comprising an interface and configured to generate emulator information, which relates to at least one power budget for an emulated data processing system, wherein the emulator information is transmitted to the data processing unit via the interface.

28. An arrangement comprising:
a data processing means comprising a data input device and a data output device; and
a data processing system emulating means, which comprises an interface, for generating emulator information, which relates to at least one power budget for an emulated data processing system, wherein the emulator information is transmitted to the data processing unit via the interface.
